(19) United States
(12) Patent Application Publication
(10) Pub. No.: US 2020/0098286 A1
(43) Pub. Date: Mar. 26, 2020

(54) Network-based online interactive language learning system

(71) Applicant: Shenzhen Eaglesoul Audio Technologies CO.,Ltd., Shenzhen (CN)

(72) Inventors: Kengfan CHEN, Shenzhen (CN); Ming LI, Guangzhou (CN); Zexing CAI, Shenzhen (CN); Xiaojiao BIN, Zhaotong (CN)

(21) Appl. No.: 16/467,444

(22) PCT Filed: Sep. 1, 2017
(86) PCT No.: PCT/CN2017/100144

§ 371 Date: Jun. 6, 2019

(30) Foreign Application Priority Data
Jun. 13, 2017 (CN) 201710444581.1

(51) Int. Cl. G09B 19/06; G09B 5/14; G09B 5/06

(52) U.S. Cl. CPC G09B 19/06; G06F 17/28; G09B 5/06; G09B 5/14

(57) ABSTRACT

Provided in the present disclosure are a network-based online interactive language learning system and method, the learning system comprising: a server host and multiple clients, wherein each of the clients transmits data in real time to the server host via an input device, and sends information from the server host to a user by virtue of an output device of each of the clients. With the system and method of the present disclosure, when using the teaching system of the present disclosure, different learners can interact with other learners at the same level, and the mother tongues of one of the two parties in interacting are target learning languages of the other party, thus quickly improving language communication ability.

### CROSS-REFERENCE TO RELATED APPLICATIONS

This application is a national stage application of PCT Application No. PCT/CN2017/100144, filed Sep. 1, 2017, and CN Application No. 201710444581.1, filed Jun. 13, 2017, the content of which is incorporated herein in the entirety by reference. Some references, which may include patents, patent applications, and various publications, are cited and discussed in the description of the present disclosure. The citation and/or discussion of such references is provided merely to clarify the description of the present disclosure and is not an admission that any such reference is “prior art” to the present disclosure described herein. All references cited and discussed in this specification are incorporated herein by reference in their entireties and to the same extent as if each reference was individually incorporated by reference.

### TECHNICAL FIELD

The present disclosure relates to the technical field of networks and particularly relates to a network-based online interactive language learning system and method.

### BACKGROUND ART

Language is an essential medium in human communication, and with the development of information technology, and development of economy and culture, communicating with foreign people freely has become a social necessity. Globally it can be seen that the number of people speaking English already exceed the number of people speaking any other language, the official language of 45 countries is English, globally 75% of television programs are in English, three-quarters of emails are written in English, and computer technology and the Internet are also built based on English. Additionally, in global economic and cultural communications, China is taking on an ever more important role, so mastering Chinese is an inevitable trend in economic globalization.

For English that is the most widespread, most of the traditional foreign language teaching activities are carried out in a manner of face-to-face teaching between a teacher and students. This manner requires long-term fixed location and fixed time learning, causing difficulties in learning for those people lacking in freedom of fixed time and convenience of transportation.

With the fast development of networks, many websites offer online foreign language teaching services set up for online educational courses, playing recorded courseware on the website according to learning progress, and performing corresponding tests to achieve learning aims. However, the problems with this method lie in, in the long term, the learner feels bored, and it is not possible to achieve the authenticity and the feel of interaction of foreign language oral language teaching with the website form of learning.

Currently interactive learning online learning systems exist, for example, granted patent number CN103794100B, “Web-based online learning platform system”, providing a web-based online learning platform system, which is installed on a web server and a database server to enable a user to perform an online learning activity via an Internet network, thus increasing the interest of a student in learning and the interaction between student and teacher, and improving learning results.

Additionally, granted patent number CN102737536B, “Method for operating language experience teaching system”, discloses a method for operating a language experience teaching system, wherein a user performs a trigger via a trigger interface on an application terminal, and then enters a normal online language teaching sub-system based on fixed courseware, a language teaching sub-system based on a virtual scenario experience, an application set sub-system of a language information resource center and tool or an extended application set mode sub-system, by running the language experience teaching system making the user as a “learner” the center, and via a fully open form, continuing to enable the “learner” to participate in entering actual scenarios encountered in daily life, but using a system presenting virtual scenarios or events to effectively improve the language ability of the “learner”.

In addition, two common ways of current online interactive foreign language teaching exist: the relationship between a teacher and a student still involves the teacher instructing the student online via a conversation; or the teacher is a virtual scene set for the same group of students learning the same language, performing a discussion in a given scene. There exist the following problems with the former way: students and teachers do not follow conversation scenarios in real life, teachers continuously correct and guide students based on a pre-set curriculum, meaning that students complete teaching tasks according to the will of the teacher, in this way conversations are limited to the curriculum and follow the lead of the teacher, students easily form a mindset, after conclusion of the learning, students have difficulty using the learned language in similar environments to think and converse with the mindset of a native speaker; and there exist the following problems with the latter way: equal and real life scenario conversation forms within the same group of students, but since those conversing are all students of the same mother tongue, their mindset is still not the mindset of a native speaker of the language being learned, similarly when encountering a native speaker of the language being learned, conversational communication is not smooth, for example, during communication, with students in the same group, if one person says “ [symbol] ” and expresses this as “Good good study, day day up”, and another person expresses “ [symbol] ”, replying with “You have two down son”, the Chinese-influenced English spoken between the two people engaged in the communication will not form a barrier to communications, but when spoken to an English or American person, often the meaning will not be understood.

With the developments in instant messaging, language learners of complementary mother tongue and target learning language also perform communication via software, for example, for communication between a Chinese person studying English and an American wishing to study Chinese, their respective language level will improve in the process of communication, but the above-mentioned method has the following problem: only complementary users can be found and any language learning progress cannot be determined. In the process of communication, often the difference is level is relatively wide, leading to low learning efficacy, for example, the language level of one party is restricted to “ [symbol] (Hello, very nice to meet you)”, “ [symbol] (today's weather is not bad)”, but the language level of the other party means they can already read and understand target language newspaper. The above-mentioned method also has the following problem: the communication between two parties often does not involve a topic, with not target or plan, meaning that although a lot of time may be spent exchanging and learning, the language level will not increase. The above-mentioned method also has the following problem: the learning process lacks guidance, the two parties will not clearly see any problems in their own learning, or which aspects need serious work.

The following problems also occur in learning in independent conversation and communication between English students and English mother tongue teachers in China: although some expressions of Chinese students do not meet the rules of English expression, for example, for the Chinese expression “ [symbol] . . . ” using “I like very . . . ” (the correct expression being “I like . . . very much”)/for the Chinese expression “ [symbol] ” using “give you” (the correct expression being “here you are”), mother tongue teachers can understand this when they hear it, and in the middle of conversation, on many occasions, the other party will not highlight this problem, meaning that Chinese students do not recognize the problem exists.

Therefore, a heretofore unaddressed need exists in the art to address the aforementioned deficiencies and inadequacies.

### SUMMARY OF THE INVENTION

In view of this, the present disclosure aims to provide a network-based online interactive language learning system and method.

According to one objective of the present disclosure, provided is an online interactive language learning system based on a network, comprising a server host and multiple clients, each of the clients transmitting data in real time to the server host via an input device, and sending information from the server host to a user by virtue of an output device of each of the clients;

the server host comprises an identity verification unit for verifying the identity of each client user to meet an identity condition of user learning, i.e. the mother tongue of at least one first client user is a target learning language of at least one second client user, the mother tongue of said at least one second client user is the target learning language of said at least one first client user, and said client users both use respective target learning languages during communication;

the server host further comprises a language conversion unit, wherein the language conversion unit converts a language used by said first client user during interaction into the mother tongue of said first client user, and transmits the mother tongue to said second client user via the server host, and said language conversion unit converts a language used by said second client user during interaction into the mother tongue of said second client user, and transmits the mother tongue to said first client user via the server host.

Furthermore, said server host comprises a language testing unit and a course unit, the language testing unit performing a language ability test when a user first logs in and each time learning is completed, and grading the user according to a result of the language ability test.

Furthermore, said server host comprises an allocation unit, which performs grouping according to user mother tongue information and target languages desired to be learned provided by the learner information database, to group users whose mother tongues and target learning languages are the same and/or complementary into the same language learning group, and allocates users in the same language learning group who are logged in at the same time and have the same language ability level to the same interaction group according to results of a language ability test.

Furthermore, said input device comprises a keyboard, a mouse, a handwriting pad, a microphone or a camera; and said output device comprises a display or a loudspeaker.

Furthermore, said system further comprises a teacher client, which allocates online a teacher having teaching credentials for the two languages in the same language learning group at the same time to the interaction group.

According to another objective of the present disclosure, provided is a network-based online interactive language learning method, comprising the following steps:

Step S101: when receiving a registration request from a user, prompting the user to fill in registration information, and saving same to a learner information database of a server host;

Step S102: testing a target language learning ability of the user via a language ability testing unit, and recording a result;

Step S103: grading the user according to the registration information in the learner information database and a result of the language ability test, and grouping users at the same level into corresponding groups of the same level;

Step S104: verifying the identity of each client user to meet an identity condition of user learning, i.e. in the same interaction group, the mother tongue C of at least one first user A is a target learning language of at least one second user B, the mother tongue E of said second user B is a target learning language of said first user A, and said first and second users A, B use the respective target learning languages E, C during communication;

Step S105: setting an interaction group discussion topic according to a user grouping level, and allocating a teacher having teaching credentials for the languages in said group at the same time to the corresponding group;

Step S106: the first user A and the second user B alternatively using the respective target learning languages to propose their own points of view on the discussion topic, and in each interaction, a language conversion unit converting the point of view of one user, who is giving an expression, to the target learning language of the other party and sending same to the other party user;

Step S107: repeating step S106 until the discussion is fully conducted or until the discussion fails to continue due to expressed language deviations between the two parties;

Step S108: the teacher commenting on the overall process of the interaction between the two parties in the discussion, and correcting problems in learning of the two parties;

Step S109: after the teacher's commenting, performing a language ability test on each user, and grading the user according to the result of the language ability test, and then after grading, grouping users at the same level into corresponding groups of the same level; and

Step S110: updating data of each user, and storing same in the learner information database.

The system and method in the present disclosure realize the reconstruction of an authentic language environment and finding defects in language expressions, thereby improving language learning efficacy and practicability.

This summary provides a simplified form of introduction and the concept will be further described in detail below. This summary does not identify the key features or essential features of the subject matter set forth, and also should not be used to limit the scope of the subject matter set forth. Furthermore, the subject matter set forth does not limit the solution to any or all the problems mentioned in any part of the present disclosure.

### BRIEF DESCRIPTION OF THE DRAWINGS

The above and other features and advantages in the present disclosure will become more apparent by describing, in detail, the exemplary embodiments thereof with reference to the accompanying drawings.

FIG. 1 is a flowchart of a network-based online interactive language learning method according to the present disclosure;

FIG. 2 is a schematic diagram of a network-based online interactive language learning system according to the present disclosure; and

FIG. 3 is a schematic diagram of a server host according to the present disclosure.

### DETAILED EMBODIMENTS OF THE PRESENT DISCLOSURE

The present disclosure will now be described more fully hereinafter with reference to the accompanying drawings, in which exemplary embodiments of the present disclosure are shown. The present disclosure may, however, be embodied in many different forms and should not be construed as limited to the embodiments set forth herein. Rather, these embodiments are provided so that this disclosure is thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting and/or capital letters has no influence on the scope and meaning of a term; the scope and meaning of a term are the same, in the same context, whether or not it is highlighted and/or in capital letters. It is appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only and in no way limits the scope and meaning of the invention or of any exemplified term. Likewise, the invention is not limited to various embodiments given in this specification.

It is understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It is understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below can be termed a second element, component, region, layer or section without departing from the teachings of the present disclosure. It is understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It are also appreciated by those of skill in the art that references to a structure or feature that is disposed “adjacent” to another feature may have portions that overlap or underlie the adjacent feature.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It is further understood that the terms “comprises” and/or “comprising,” or “includes” and/or “including” or “has” and/or “having” when used in this specification specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the figures. It is understood that relative terms are intended to encompass different orientations of the device in addition to the orientation shown in the figures. For example, if the device in one of the figures is turned over, elements described as being on the “lower” side of other elements would then be oriented on the “upper” sides of the other elements. The exemplary term “lower” can, therefore, encompass both an orientation of lower and upper, depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below. Unless otherwise defined, all terms (including technical and scientific terms) used herein have the same meaning as commonly understood by one of ordinary skill in the art to which the present disclosure belongs. It is further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around,” “about,” “substantially” or “approximately” shall generally mean within 20 percent, preferably within 10 percent, and more preferably within 5 percent of a given value or range. Numerical quantities given herein are approximate, meaning that the terms “around,” “about,” “substantially” or “approximately” can be inferred if not expressly stated.

As used herein, the terms “comprise” or “comprising,” “include” or “including,” “carry” or “carrying,” “has/have” or “having,” “contain” or “containing,” “involve” or “involving” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method may be executed in different order (or concurrently) without altering the principles of the invention.

Embodiments of the invention are illustrated in detail hereinafter with reference to accompanying drawings. It should be understood that specific embodiments described herein are merely intended to explain the invention, but not intended to limit the invention. The disclosure will now be described in details in connection with the embodiments. The following embodiments are intended for facilitating those skilled in the art to understand the present disclosure, instead of limiting the present disclosure in any way. It should be noted that a number of variations and modifications may be made by those skilled in the art without departing from the inventive concept, all of which fall within the scope of protection of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor. The term “code”, as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The term “interface”, as used herein, generally refers to a communication tool or means at a point of interaction between components for performing data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

In the present disclosure, computer components may include physical hardware components and virtual software components. One of ordinary skill in the art would appreciate that, unless otherwise indicated, these computer components may be implemented in, but not limited to, the forms of software, firmware or hardware components, or a combination thereof.

The apparatuses, systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

For the problems existing in the prior art, the present disclosure proposes a network-based online interactive language learning system and method, aiming to reconstruct an authentic language environment and finding defects in language expressions, thereby improving language learning efficacy and practicability.

To make the technical solutions of the present disclosure clearer and more readily understood, the technical solution of the present disclosure is further described in detail below together with the drawings and examples.

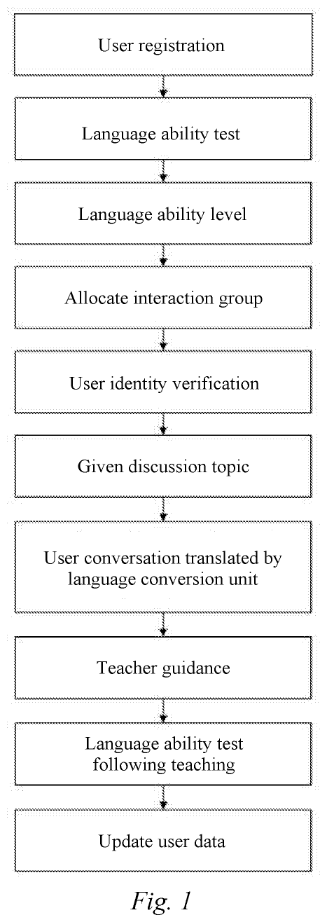

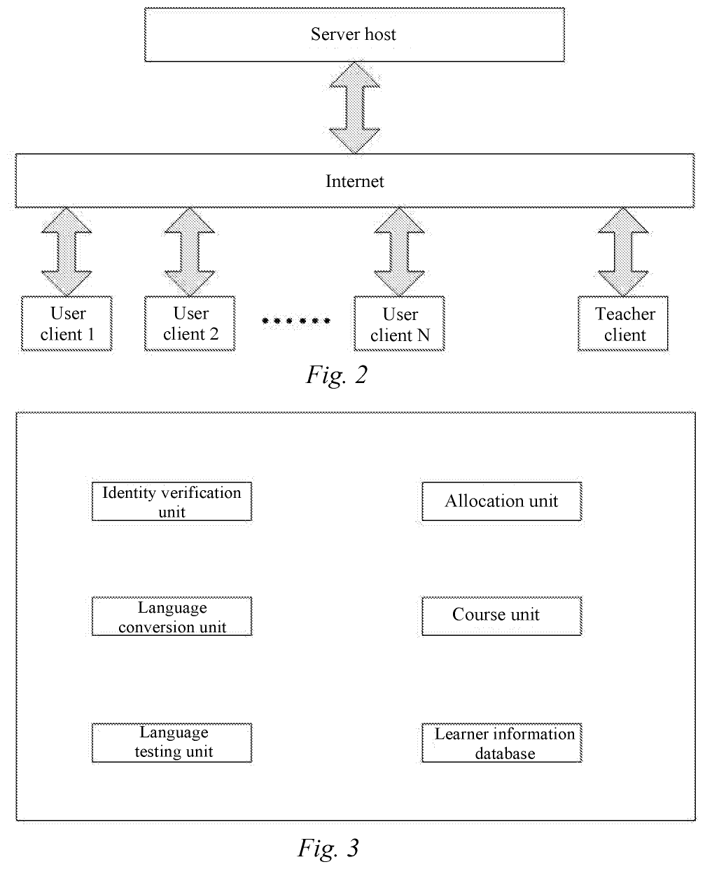

FIG. 1 is a flowchart of a network-based online interactive language learning method according to the present disclosure.

According to one objective of the present disclosure, with the aid of the Internet, an online interactive language learning service is provided for language learners in different countries.

Step S101: when receiving a registration request from a user, prompting the user to fill in registration information, and saving same to a learner information database of a server host.

The registration information can be a pre-generated information list, comprising social attributes of a user, such as nationality, mother tongue, target learning language, age, gender, income, religion, occupation, and can also comprise the educational background of a learner, such as school graduation, subjects, educational history, and research experience, and it is particularly advantageous to comprise information about the interests of the learner, such as reading preferences, sports preferences, and arts preferences.

The objective of collecting said information is to provide a user label that is as comprehensive, accurate and personalized as possible, and analyse the interests of the user from the identities and degrees of dependence of the user to different labels based on said labeled interest model, and construct a conceptual hierarchy to search for shared labels, the found shared labels reflecting learner interests, and further grouping the users according to the labels, and thus interactions can be more easily performed between users with the same interests, and language deep learning can be more easily realized.

In one example, a user, Tom, of American nationality, with English mother tongue, a target learning language of Chinese, and an interest in basket ball and a user, Xiao Ming, of Chinese nationality, with Chinese mother tongue, a target learning language of English and an interest in basketball more easily perform interactive learning.

Step S102: testing a target language learning ability of the user via a language ability testing unit, and recording a result.

In this step, language ability tests are provided to users with different target learning languages.

In one example, a Chinese Proficiency Test (HSK) is given to Tom, and the result is recorded, and a Test of English as a Foreign Language (TOEFL) is given to Xiao Ming, and the result is recorded.

Step S103: grading the user according to the registration information in the learner information database and a result of the language ability test, and grouping users at the same level into corresponding groups of the same level.

The significance of this step is to carry out targeted teaching to users of different level.

In one example, with the result of the HSK test being the first 30-35% of the total number of people taking the test, Tom is allocated to “HSK level 30-35%”; with the result of the TOEFL test being the first 30-35% of the total number of people taking the test, Xiao Ming is allocated to “TOEFL level 30-35%”; with the result of the HSK test being the first 30-35% of the total number of people taking the test and a mother tongue of English and a target learning language of Chinese, Jerry is allocated to “HSK level 30-35%”; with the result of the TOEFL test being the first 15-20% of the total number of people taking the test and a mother tongue of Chinese and a target learning language of English, Xiao Qiang is allocated to “TOEFL level 15-20%”.

Preferably, after step S103, the method further comprises step S1031: performing grouping according to user mother tongue information and target languages desired to be learned provided by the learner information database, to group users whose mother tongues and target learning languages are the same and/or complementary into the same language learning group, and allocating users in the same language learning group who are logged in at the same time and have the same language ability level to the same interaction group according to results of a language ability test.

The significance of this step is to put users with the same target language level in touch, promoting interaction, preventing abilities not matching where the distance between levels is too great, and the ability of the party with the stronger ability not improving, and the mental burden being too great on the party with the lower ability, while enabling the teacher to grasp the abilities of the two parties to teach according to individual aptitude.

In one example, Tom and Jerry with the same level “30-35%” in their respective language tests, English mother tongue and Chinese target learning language, and Xiao Ming with Chinese mother tongue and English target learning language are allocated to the same interaction group: “interaction group 30-35%”.

Step S104: verifying the identity of each client user to meet an identity condition of user learning, i.e. in the same interaction group, the mother tongue C of at least one first user A is a target learning language of at least one second user B, the mother tongue E of said second user B is a target learning language of said first user A, and said first and second users A, B use the respective target learning languages E, C during communication.

The significance of this step is meeting initial communication conditions, i.e. each interaction group at least comprising two users who can complement each other's language learning.

Step S105: setting an interaction group discussion topic according to a user grouping level, and allocating a teacher having teaching credentials for the languages in said group at the same time to the corresponding group.

The significance of this step is to propose suitable topics according to interests and likes and language abilities, enabling full and in-depth interactive communication, while enabling the instructing teacher to grasp the learning situation of all students, record any problems existing, and where necessary, give instruction.

Step S106: the first user and the second user alternatively using the respective target learning languages to propose their own points of view on the discussion topic, and in each interaction, a language conversion unit converting the point of view of one user, who is giving an expression, to the target learning language of the other party and sending same to the other party user.

In one example, said first user A uses a target learning language E to propose his/her point of view P on this topic, and this point of view P is converted by the language conversion unit to express a first point of view P′ in the target learning language C of the second user B;

then, the converted point of view P′ is sent to the second user B, the second user B uses the target learning language C of the second user B to propose his/her own point of view Q on the point of view P′, and the point of view Q is converted by the language conversion unit to express a second point of view Q′ in the target learning language E of the first user A; and

then, the converted second point of view Q′ is sent to the first user A, the first user A uses the target learning language E of the first user A to propose his/her own point of view P″ on the point of view Q′, and the point of view P″ is converted by the language conversion unit to express a second point of view P″′ in the target learning language C of the second user B.

The significance of this step is to enable different users in the same interaction group with the same and/or different target learning languages to discuss respective points of view using their target learning languages via the language conversion unit, and if the expressions of the two parties are both consistent with the true meaning, i.e. there is no problem with the expressions, interaction can continue until the pre-set topic discussion is comprehensive and in-depth, and in this process, since the two parties both use ways of reasoning in their respective mother tongues, one party receiving information is enabled to get in-depth understanding of the reasoning and logic of the other party, and mastery through repeated training.

In addition to this, when one party deviates in expression, since the language conversion unit will not correct errors in ways of expression, this erroneous expression will be translated into a sentence differing from the idea of the person expressing and transferred to the party receiving information, at this point, the party receiving the information will not be clear on the semantics of the other party and will respond based on the semantics given by the language conversion unit, the response will be sent to the party initially giving the expression via the language conversion unit, and thus since there is a problem in the language logic, the party initially giving an expression will see the problem, and therefore, can then solve the problem by re-expressing or requesting input from the instructing teacher, and using this method for language learning means that the language learner understands the expression more deeply.

In one example, supposing that in one conversation there are four sentences and semantics, a, b, c and d, wherein b is normal logic in response to sentence a, c is normal logic in response to sentence b, and d is normal logic in response to sentence c, and the expressions of the two parties are both real thinking, the conversation of the two parties would be as follows:

“Tom expresses: sentence a;

Xiao Ming receives the semantics of a and responds: sentence b;

Tom receives the semantics of b and responds: sentence c;

Xiao Ming receives the semantics of c and responds: sentence d.

End of conversation.”

If, when expressing sentence a, Tom makes an error and says sentence a′, the semantics a′ of sentence a′ will be sent to Xiao Ming via the semantics conversion unit, Xiao Ming will respond with b′ based on semantics a′, semantics b′ will be sent to Tom via the semantics conversion unit, and at this point, Tom will discover that there is no correlation between semantics b′ and semantics a, i.e. in normal logic, semantics b′ is not the response to semantics a, and thus Tom can discover a deviation in the semantics of the expressions and, at this point, can re-start this section of the conversation with Xiao Ming or request teacher guidance.

Step S107: repeating step S106 until the discussion is fully conducted or until the discussion fails to continue due to expressed language deviations between the two parties.

Step S108: the teacher commenting on the overall process of the interaction between the two parties in the discussion, and correcting problems in learning of the two parties.

In a preferred embodiment of step S108, if the discussion has been fully conducted in step S107, concluding this discussion; and if the discussion fails to continue due to expressed language deviations between the two parties in step S107, after the teacher's commenting, continuing with the discussion, until the discussion is fully conducted, and then concluding this discussion.

Step S109: after the teacher's commenting, performing a language ability test on each user, and grading the user according to the result of the language ability test, and then after grading, grouping users at the same level into corresponding groups of the same level.

Step S110: updating data of each user, and storing same in the learner information database.

Furthermore, the ways of language learning at least comprise verbal communication.

Furthermore, the ways of language learning at least comprise textual communication.

Furthermore, all the expressions of each interaction for each user are recorded for reference by the teacher in a next interaction.

According to another objective of the present disclosure, provided is a computer device comprising a memory, a processor and a computer program stored on the memory and operable on the processor, wherein the program, when executed by the processor, can implement the steps of the method as described above.

According to another objective of the present disclosure, a computer storage medium is provided, which stores a program which can be executed by a computer, wherein the program, when executed, can implement the steps of the method as described above.

According to another aspect of the present disclosure, provided is a network-based online interactive language learning system, comprising a server host and multiple clients, each of the clients transmitting data in real time to the server host via an input device, and sending information from the server host to a user by virtue of an output device of each of the clients;

the server host comprises an identity verification unit for verifying the identity of each client user to meet an identity condition of user learning, i.e. the mother tongue of at least one first client user is a target learning language of at least one second client user, the mother tongue of said at least one second client user is the target learning language of said at least one first client user, and said client users both use respective target learning languages during communication;

the server host further comprises a language conversion unit, wherein the language conversion unit converts a language used by said first client user during interaction into the mother tongue of said first client user, and transmits the mother tongue to said second client user via the server host, and said language conversion unit converts a language used by said second client user during interaction into the mother tongue of said second client user, and transmits the mother tongue to said first client user via the server host.

In one example, the language conversion unit quickly and accurately translates a first sentence expressed by a first user into a second sentence with a corresponding semantics, and transfers same to a second user. The second user, according to the semantics of the second sentence, responds with a third sentence to this phrase. The language conversion unit quickly and accurately translates the third sentence expressed by the second user into a fourth sentence with a corresponding semantics and transfers same to the first user.

Further, said server host comprises a language testing unit and a course unit, the language testing unit performing a language ability test when a user first logs in and each time learning is completed, and grading the user according to a result of the language ability test; and the course unit storing teaching courses suited to users with different results.

Furthermore, said server host comprises an allocation unit, which performs grouping according to user mother tongue information and target languages desired to be learned provided by the learner information database, to group users whose mother tongues and target learning languages are the same and/or complementary into the same language learning group, and allocates users in the same language learning group who are logged in at the same time and have the same language ability level to the same interaction group according to results of a language ability test.

Furthermore, said input device comprises a keyboard, a mouse, a handwriting pad, a microphone or a camera; and said output device comprises a display or a loudspeaker.

Furthermore, said system further comprises a teacher client, which allocates online a teacher having teaching credentials for the two languages in the same language learning group at the same time to the interaction group.

The above-mentioned system and method can be used in online language teaching, and thereby solve the technical problems mentioned in the background art section of mindset, lack of meaning of phrases and the lack of reality in language teaching.

It should be noted that the configuration and/method herein are substantially exemplary, and the specific embodiments and examples should not be deemed as limiting as many modifications are possible. The specific processes or method herein can indicate one or many in any number of processing tasks. Therefore, each action shown can be executed in the order shown, executed in another order, executed in parallel or omitted in certain circumstances. Similarly, the order of the above-mentioned procedures can be altered.

The subject matter of the present disclosure comprises procedures, systems and configurations, and all novel and non-obvious combinations and sub-combinations of other features, function, actions, and/or characteristics, and any and all equivalents disclosed herein.

### INDUSTRIAL APPLICABILITY

The network-based online interactive language learning system proposed in the present application realizes the reconstruction of an authentic language environment and finds defects in language expressions, thereby improving language learning efficacy and practicability.

The foregoing description of the exemplary embodiments of the present disclosure has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

1. A network-based online interactive language learning system, comprising a server host and multiple clients, each of the clients transmitting data in real time to the server host via an input device and sending information from the server host to a user by virtue of an output device of each of the clients; and the server host being provided with a learner information database for storing user information, wherein
the server host comprises an identity verification unit for verifying the identity of each client user to meet an identity condition of user learning, the mother tongue of at least one first client user is a target learning language of at least one second client user, the mother tongue of said at least one second client user is the target learning language of said at least one first client user, and said client users both use respective target learning languages during communication;
the server host further comprises a language conversion unit, wherein the language conversion unit converts a language used by said first client user during interaction into the mother tongue of said first client user, and transmits the mother tongue to said second client user via the server host, and said language conversion unit converts a language used by said second client user during interaction into the mother tongue of said second client user, and transmits the mother tongue to said first client user via the server host;
said server host further comprises an allocation unit which performs grouping according to user mother tongue information and target languages desired to be learned provided by the learner information database, to group users whose mother tongues and target learning languages are the same and/or complementary into the same language learning group; and
said server host further comprises a teacher client which allocates a teacher having teaching credentials for the languages in said group to the corresponding group.

2. The system according to claim 1, wherein
said server host further comprises a language testing unit and a course unit, the language testing unit performing a language ability test when a user first logs in and each time learning is completed, and grading the user according to a result of the language ability test; and the course unit storing teaching courses suited to users with different results.

3. The system according to claim 2, wherein
the allocation unit allocates users in the same language learning group who are logged in at the same time and have the same language ability level to the same interaction group according to the result of the language ability test.

4. The system according to claim 1, wherein
said input device comprises a keyboard, a mouse, a handwriting pad, a microphone or a camera.

5. The system according to claim 1, wherein
said output device comprises a display or a loudspeaker.

6. A network-based online interactive language learning method, comprising the following steps:
Step S101: when receiving a registration request from a user, prompting the user to fill in registration information, and saving same to a learner information database of a server host;
Step S102: testing a target language learning ability of the user via a language ability testing unit, and recording a result;
Step S103: grading the user according to the registration information in the learner information database and a result of the language ability test, and grouping users at the same level into corresponding groups of the same level;
Step S104: verifying the identity of each client user to meet an identity condition of user learning, i.e. in the same interaction group, the mother tongue C of at least one first user A is a target learning language of at least one second user B, the mother tongue E of said second user B is a target learning language of said first user A, and said first and second users A, B use the respective target learning languages E, C during communication;
Step S105: setting an interaction group discussion topic according to a user grouping level, and allocating a teacher having teaching credentials for the languages in said group at the same time to the corresponding group;
Step S106: the first user A and the second user B alternatively using the respective target learning languages to propose their own points of view on the discussion topic, and in each interaction, a language conversion unit converting the point of view of one user, who is giving an expression, to the target learning language of the other party and sending same to the other party user;
Step S107: repeating step S106 until the discussion is fully conducted or until the discussion fails to continue due to expressed language deviations between the two parties;
Step S108: the teacher commenting on the overall process of the interaction between the two parties in the discussion, and correcting problems in learning of the two parties;
Step S109: after the teacher's commenting, performing a language ability test on each user, and grading the user according to the result of the language ability test, and then after grading, grouping users at the same level into corresponding groups of the same level; and
Step S110: updating data of each user, and storing same in the learner information database.

7. The method according to claim 6, wherein
after step S103, the method further comprises step S1031: performing grouping according to user mother tongue information and target languages desired to be learned provided by the learner information database, to group users whose mother tongues and target learning languages are the same and/or complementary into the same language learning group, and allocating users in the same language learning group who are logged in at the same time and have the same language ability level to the same interaction group according to results of a language ability test.

8. The method according to claim 6, wherein
in step S108, if the discussion has been fully conducted in step S107, concluding this discussion; and if the discussion fails to continue due to expressed language deviations between the two parties in step S107, after the teacher's commenting, continuing with the discussion, until the discussion is fully conducted, and then concluding this discussion.

9. The method according to claim 6, wherein
the registration information filled in by said user at least comprises age, gender, nationality, occupation, and interests; and ways of language learning at least comprise textual communication or verbal communication.

10. The method according to claim 6, wherein
all the expressions of each interaction for each user are recorded for reference by the teacher in a next interaction.

11. A computer device, comprising a memory, a processor, and a computer program stored on the memory and operable on the processor, wherein the program, when executed by the processor, can implement the steps of the method of claim 6.

12. A computer storage medium, storing a program which can be executed by a computer, wherein the program, when executed, can implement the steps of the method of claim 6.

13. The computer device of claim 11, wherein
after step S103, the method further comprises step S1031: performing grouping according to user mother tongue information and target languages desired to be learned provided by the learner information database, to group users whose mother tongues and target learning languages are the same and/or complementary into the same language learning group, and allocating users in the same language learning group who are logged in at the same time and have the same language ability level to the same interaction group according to results of a language ability test.

14. The computer device of claim 11, wherein
in step S108, if the discussion has been fully conducted in step S107, concluding this discussion; and if the discussion fails to continue due to expressed language deviations between the two parties in step S107, after the teacher's commenting, continuing with the discussion, until the discussion is fully conducted, and then concluding this discussion.

15. The computer device of claim 11, wherein
the registration information filled in by said user at least comprises age, gender, nationality, occupation, interests, etc.; and ways of language learning at least comprise textual communication or verbal communication.

16. The computer device of claim 11, wherein
all the expressions of each interaction for each user are recorded for reference by the teacher in a next interaction.

17. The computer storage medium of claim 12, wherein
after step S103, the method further comprises step S1031: performing grouping according to user mother tongue information and target languages desired to be learned provided by the learner information database, to group users whose mother tongues and target learning languages are the same and/or complementary into the same language learning group, and allocating users in the same language learning group who are logged in at the same time and have the same language ability level to the same interaction group according to results of a language ability test.

18. The computer storage medium of claim 12, wherein
in step S108, if the discussion has been fully conducted in step S107, concluding this discussion; and if the discussion fails to continue due to expressed language deviations between the two parties in step S107, after the teacher's commenting, continuing with the discussion, until the discussion is fully conducted, and then concluding this discussion.

19. The computer storage medium of claim 12, wherein
the registration information filled in by said user at least comprises age, gender, nationality, occupation, interests, etc.; and ways of language learning at least comprise textual communication or verbal communication.

20. The computer storage medium of claim 12, wherein
all the expressions of each interaction for each user are recorded for reference by the teacher in a next interaction.
